(19) United States
(12) Patent Application Publication
(10) Pub. No.: US 2024/0213689 A1
(43) Pub. Date: Jun. 27, 2024

(54) Array Antenna and Preparation Method thereof, and Electronic Apparatus

(71) Applicants: Beijing BOE Sensor Technology Co., Ltd., Beijing (CN); BOE Technology Group Co., Ltd., Beijing (CN)

(72) Inventors: Xiaoqiang YANG, Beijing (CN); Lu CHEN, Beijing (CN); Cuiwei TANG, Beijing (CN); Wei ZHAO, Beijing (CN); Yiming WANG, Beijing (CN); Chuncheng CHE, Beijing (CN)

(21) Appl. No.: 17/919,752

(22) PCT Filed: Oct. 27, 2021
(86) PCT No.: PCT/CN2021/126813

§ 371 Date: Oct. 19, 2022

(51) Int. Cl. H01Q 21/06; H01Q 1/52; H01Q 21/00

(52) U.S. Cl. CPC H01Q 21/065; H01Q 1/523; H01Q 21/0093

(57) ABSTRACT

An array antenna and a preparation method thereof, and an electronic apparatus are provided. The array antenna includes: a first dielectric substrate (100) and multiple antenna units (200) disposed on the first dielectric substrate (100), wherein, multiple isolation posts (102) are disposed within the first dielectric substrate (100); multiple antenna units (200) are divided into multiple groups, and at least one isolation post (102) is disposed between two adjacent groups of the antenna units (200).

### CROSS-REFERENCE TO RELATED APPLICATION

The present application is a U.S. National Phase Entry of International Application No. PCT/CN2021/126813 having an international filing date of Oct. 27, 2021, the content of which is incorporated into this application by reference.

### TECHNICAL FIELD

The present disclosure relates to, but is not limited to, the technical field of communications, and in particular to an antenna array and a preparation method thereof, and an electronic apparatus.

### BACKGROUND

In modern communication devices, antenna systems often use multiple antenna units to receive and transmit signals at the same time. However, mutual energy coupling between the multiple antenna units will occur, and crosstalk of coupling energies between various antenna units will lead to a decrease of a radiation efficiency of an antenna, deterioration of a large-angle scanning performance, and a decrease of a communication capacity of the whole communication system, etc. In addition, mutual coupling will also have a direct influence on an electrical performance of the antenna itself, such as a distortion of a radiation pattern, a change of a current distribution on a surface of a radiation unit, an imbalance of impedance matching, and decreases of overall transceiver gain and efficiency of the antenna, etc.

### SUMMARY

The following is a summary of subject matters described herein in detail. The summary is not intended to limit the protection scope of claims.

An embodiment of the present disclosure provides an array antenna, which includes: a first dielectric substrate and multiple antenna units disposed on the first dielectric substrate, wherein, multiple isolation posts are disposed within the first dielectric substrate; the multiple antenna units are divided into multiple groups, and at least one isolation post is disposed between two adjacent groups of the antenna units.

In some exemplary embodiments, the first dielectric substrate further includes spaced regions around the antenna units, and an orthographic projection of the spaced regions on the first dielectric substrate includes an orthographic projection of the isolation posts on the first dielectric substrate.

In some exemplary embodiments, the isolation posts are arranged in multiple rows and multiple columns, and at least one row of the isolation posts is disposed between two adjacent groups of antenna units in a first direction; and at least one column of the isolation posts is disposed between two adjacent groups of antenna units in a second direction.

In some exemplary embodiments, the multiple antenna units include m rows and n columns of antenna units, m and n are natural numbers, each group of the antenna units includes one antenna unit, and the multiple isolation posts are arranged in (m+1) rows and (n+1) columns; two sides of a first row of the antenna units to two sides of an m-th row of the antenna units are all provided with one row of the isolation posts; and two sides of a first column of the antenna units to two sides of an n-th column of the antenna units are all provided with one column of the isolation posts.

In some exemplary embodiments, the multiple antenna units include m rows and n columns natural numbers, m and n are natural numbers, each group of the antenna units includes one antenna unit, and the multiple isolation posts are arranged in (m−1) rows and (n−1) columns; two sides of a second row of the antenna units to two sides of an (m−1)-th row of the antenna units are all provided with one row of the isolation posts; and two sides of a second column of the antenna units to two sides of an (n−1)-th column of the antenna units are all provided with one column of the isolation posts.

In some exemplary embodiments, an arrangement of the isolation posts forms multiple enclosed patterns, wherein at least one of the enclosed patterns is disposed around one group of the antenna units.

In some exemplary embodiments, the multiple antenna units include m rows and n columns of antenna units, m and n are natural numbers, and each group of the antenna units includes a*b antenna units, wherein 1≤a≤m, and 1≤b≤n; and an arrangement of the isolation posts forms (m/a)*(n/b) enclosed patterns, wherein each of the enclosed patterns surrounds one group of the antenna units.

In some exemplary embodiments, the first dielectric substrate includes a first surface and a second surface disposed oppositely, and the antenna units are disposed on the first surface; and the isolation posts satisfy at least one of the following: the isolation posts penetrate at least one of the first surface and the second surface; or, the isolation posts are disposed inside the first dielectric substrate, and the isolation posts do not penetrate the first surface or the second surface.

In some exemplary embodiments, a spacing between two adjacent isolation posts corresponding to one same group of the antenna units is less than or equal to 0.25* a center wavelength, wherein * is a multiplication sign, and the center wavelength is a wavelength corresponding to a center frequency of an electromagnetic wave received and transmitted by the array antenna.

In some exemplary embodiments, a spacing between an antenna unit and an isolation post corresponding to the antenna unit is less than or equal to 0.25* a center wavelength, wherein * is a multiplication sign, and the center wavelength is a wavelength corresponding to a center frequency of an electromagnetic wave received and transmitted by the array antenna.

In some exemplary embodiments, a shape of the isolation post is a cylinder, a polygonal prism, or an irregular column.

In some exemplary embodiments, the isolation post is a solid column or a hollow column.

In some exemplary embodiments, a material of the isolation post is metal.

In some exemplary embodiments, the first dielectric substrate is a glass or a printed circuit board dielectric substrate.

In some exemplary embodiments, the array antenna is a transmissive liquid crystal array antenna, a reflective liquid crystal array antenna, or a glass-based array antenna.

An embodiment of the present disclosure further provides an electronic apparatus, which includes: at least one array antenna as previously described.

An embodiment of the present disclosure further provides a method for preparing an array antenna, which is for preparing the array antenna as previously described, wherein the method includes: forming multiple isolation posts within a first dielectric substrate; and forming multiple antenna units on the first dielectric substrate, wherein the multiple antenna units are divided into multiple groups, and at least one isolation post is disposed between two adjacent groups of the antenna units.

Other aspects may be understood upon the drawings and the detailed description are read and understood.

### BRIEF DESCRIPTION OF DRAWINGS

Accompanying drawings are used for providing further understanding of technical solutions of the present disclosure, constitute a part of the specification, and together with the embodiments of the present disclosure, are used for explaining the technical solutions of the present disclosure but do not constitute limitations on the technical solutions of the present disclosure. Shapes and sizes of one or more components in the drawings do not reflect true scales, and are only intended to schematically describe contents of the present disclosure.

FIG. 1 is a schematic diagram of a top-view structure of an array antenna according to an exemplary embodiment of the present disclosure.

FIGS. 2 to 4 are schematic diagrams of three sectional structures of an AA region in FIG. 1.

FIGS. 5 to 8 are schematic diagrams of four distribution structures of isolation posts and antenna units according to exemplary embodiments of the present disclosure.

FIGS. 9A to 9D are schematic diagrams of four distribution structures of isolation posts and a first dielectric substrate according to exemplary embodiments of the present disclosure.

FIGS. 10A to 10E are schematic diagrams of five structures of isolation posts according to exemplary embodiments of the present disclosure.

FIGS. 11A to 11B are schematic diagrams of two other structures of isolation posts according to exemplary embodiments of the present disclosure.

FIG. 12 is a schematic diagram of a comparison of isolation degrees between antenna units before and after isolation posts are added in an array antenna according to an exemplary embodiment of the present disclosure.

FIG. 13 is a schematic diagram of a structure of an electronic apparatus according to an exemplary embodiment of the present disclosure.

### DETAILED DESCRIPTION

The embodiments of the present disclosure will be described below in combination with the drawings in detail. Implementations may be implemented in multiple different forms. Those of ordinary skills in the art may easily understand such a fact that implementation modes and contents may be transformed into one or more forms without departing from the purpose and scope of the present disclosure. Therefore, the present disclosure should not be explained as being limited to contents described in following implementations only. The embodiments in the present disclosure and features in the embodiments may be combined randomly with each other without a conflict.

In the drawings, a size of one or more constituent elements, a thickness of a layer, or a region is sometimes exaggerated for clarity. Therefore, one implementation of the present disclosure is not necessarily limited to the dimensions, and shapes and sizes of multiple components in the accompanying drawings do not reflect actual scales. In addition, the drawings schematically illustrate ideal examples, and one implementation of the present disclosure is not limited to the shapes, numerical values, or the like shown in the drawings.

Ordinal numerals such as “first”, “second” and “third” in the present disclosure are set to avoid confusion of constituent elements, but not intended for restriction in quantity. “Multiple” in the present disclosure means a quantity of two or more.

In the present disclosure, for convenience, wordings “central”, “up”, “down”, “front”, “back”, “vertical”, “horizontal”, “top”, “bottom”, “inside”, “outside” and the like indicating orientation or positional relationships are used to illustrate positional relationships between constituent elements with reference to the drawings. These wordings are not intended to indicate or imply that involved devices or elements must have specific orientations and be structured and operated in the specific orientations, but only to facilitate describing the present specification and simplify the description, and thus should not be understood as limitations on the present disclosure. The positional relationships between the constituent elements are changed as appropriate based on directions which are used for describing the constituent elements. Therefore, appropriate replacements can be made according to situations without being limited to the wordings for the description in the specification.

In the present disclosure, unless otherwise specified and defined, terms “mounting”, “mutual connection” and “connection” should be understood in a broad sense. For example, the connection may be a fixed connection, or a detachable connection, or an integrated connection. It may be a mechanical connection or an electrical connection. It may be a direct mutual connection, or an indirect connection through middleware, or internal communication between two components. Those of ordinary skills in the art may understand meanings of the above-mentioned terms in the present disclosure according to situations.

In the present disclosure, “electric connection” includes a case where constituent elements are connected through an element with a certain electrical effect. The “element with the certain electrical effect” is not particularly limited as long as electrical signals may be sent and received between the connected constituent elements. Examples of the “element with the certain electrical effect” not only include electrodes and wirings, but also include switching elements (such as transistors), resistors, inductors, capacitors, other elements with one or more functions, etc.

In the present disclosure, “parallel” refers to a state in which an angle formed by two straight lines is above −10 degrees and below 10 degrees, and thus may include a state in which the angle is above −5 degrees and below 5 degrees. In addition, “perpendicular” refers to a state in which an angle formed by two straight lines is above 80 degrees and below 100 degrees, and thus may include a state in which the angle is above 85 degrees and below 95 degrees.

In the present disclosure, “about” and “approximate” refer to a case that a boundary is not defined strictly and a process and measurement error within a range is allowed.

At least one embodiment of the present disclosure provides an array antenna, which includes: a first dielectric substrate and multiple antenna units disposed on the first dielectric substrate; multiple isolation posts are disposed within the first dielectric substrate; the multiple antenna units are divided into multiple groups, and at least one isolation post is disposed between two adjacent groups of the antenna units.

By forming multiple isolation posts within the first dielectric substrate, the array antenna provided by the embodiment of the present disclosure can effectively suppress dielectric coupling between antenna units, reduce coupling energies, and ensure a high isolation performance between antennas, and may further improve a large-angle scanning performance of the array antenna and optimize antenna parameters. The array antenna provided by the embodiment of the present disclosure may improve an antenna structure from a two-dimensional plane to a three-dimensional structure, thereby improving a design freedom degree.

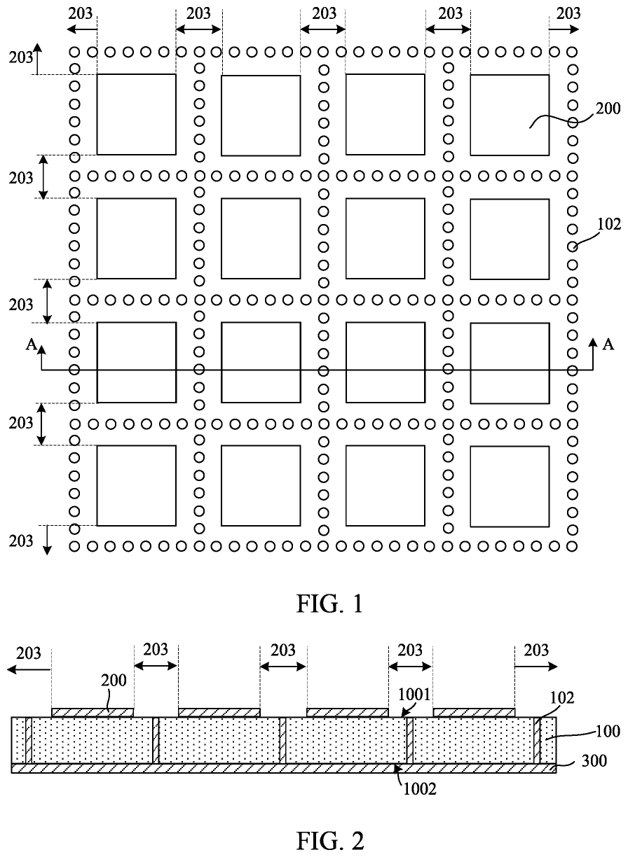

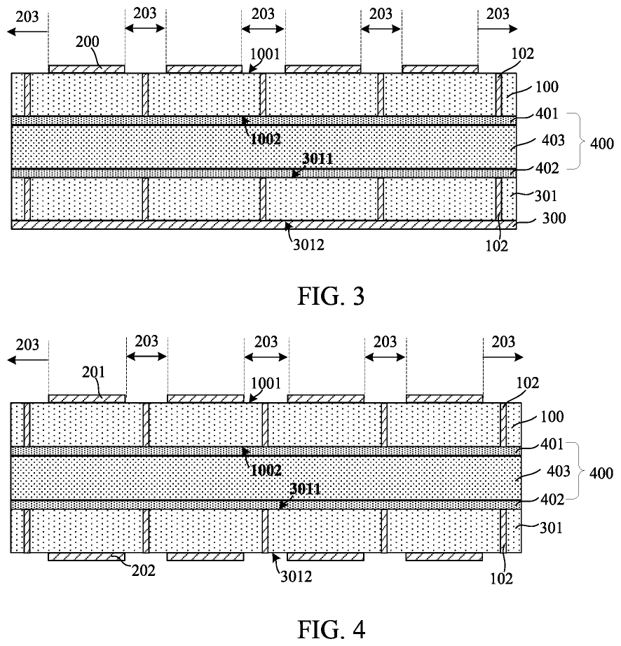

FIG. 1 is a schematic diagram of a top-view structure of an array antenna according to an exemplary embodiment of the present disclosure, and FIGS. 2 to 4 are schematic diagrams of several sectional structures of an AA region in FIG. 1. As shown in FIGS. 1 to 4, an embodiment of the present disclosure provides an array antenna, which includes: a first dielectric substrate 100 and multiple antenna units 200 disposed on the first dielectric substrate 100, wherein multiple isolation posts 102 are disposed within the first dielectric substrate 100; the multiple antenna units 200 are divided into multiple groups, and at least one isolation post 102 is disposed between two adjacent groups of the antenna units 200.

In some exemplary embodiments, the array antenna may be a transmissive liquid crystal array antenna, a reflective liquid crystal array antenna, or a glass-based array antenna. However, the embodiments are not limited thereto.

As shown in FIG. 2, the array antenna includes a first dielectric substrate 100, wherein the first dielectric substrate 100 includes a first surface 1001 and a second surface 1002 disposed oppositely, multiple antenna units 200 are disposed on the first surface 1001, and a ground plate 300 is disposed on the second surface 1002, and multiple isolation posts 102 are disposed within the first dielectric substrate 100; the multiple antenna units 200 are divided into multiple groups, and at least one isolation post 102 is disposed between two adjacent groups of the antenna units 200.

As shown in FIG. 3, the array antenna includes a first dielectric substrate 100 and a second dielectric substrate 301 disposed oppositely, wherein the first dielectric substrate 100 includes a first surface 1001 and a second surface 1002 disposed oppositely, multiple antenna units 200 are disposed on the first surface 1001, a first conductive layer 401 is disposed on the second surface 1002, and multiple isolation posts 102 are disposed within the first dielectric substrate 100; the multiple antenna units 200 are divided into multiple groups, and at least one isolation post 102 is disposed between two adjacent groups of the antenna units 200. The second dielectric substrate 301 includes a third surface 3011 and a fourth surface 3012 disposed oppositely, wherein a second conductive layer 402 is disposed on the third surface 3011, a ground plate 300 is disposed on the fourth surface 3012, and multiple isolation posts 102 are disposed within the second dielectric substrate 301. An orthographic projection of the second conductive layer 402 on the first dielectric substrate 100 partially overlaps with an orthographic projection of the first conductive layer 401 on the first dielectric substrate 100. The first conductive layer 401, the second conductive layer 402, and a third dielectric layer 403 disposed between the first conductive layer 401 and the second conductive layer 402 form a phase shifting structure 400. In some exemplary embodiments, the third dielectric layer 403 includes a liquid crystal material. However, the embodiments of the present disclosure are not limited to this. In some exemplary embodiments, the third dielectric layer may adopt another material which is similar to the liquid crystal material and can change a dielectric constant thereof based on a change of an electric field. For example, the third dielectric layer 403 may include a ferroelectric material.

In some exemplary embodiments, in a reflective array antenna as shown in FIG. 3, the isolation posts 102 may be disposed only within the first dielectric substrate 100 and not disposed within the second dielectric substrate 301. Or, the isolation posts 102 may be disposed only within the second dielectric substrate 301 and not disposed within the first dielectric substrate 100. Or, the isolation posts 102 may be disposed within both the first dielectric substrate 100 and the second dielectric substrate 301. The present disclosure is not limited thereto.

In the present embodiment, when the isolation posts 102 are disposed within both the first dielectric substrate 100 and the second dielectric substrate 301, isolation posts 102 within the first dielectric substrate 100 are arranged according to positions of the multiple antenna units on the first dielectric substrate for suppressing dielectric coupling between the multiple antenna units on the first dielectric substrate. For example, the isolation posts 102 within the first dielectric substrate 100 may be disposed in spaced regions around the antenna units. Isolation posts 102 within the second dielectric substrate 301 are arranged according to an electric field distribution on the ground plate 300 for limiting flowing of currents on the ground plate 300, which has an effect of reducing dielectric coupling on the ground plate 300. Exemplarily, the ground plate 300 may be a Defected Ground Structure (DGS), i.e., a periodic or aperiodic grid structure is etched on the ground plate 300 to change a distributed inductance and a distributed capacitance of a transmission line, and obtain a band-stop characteristic and a slow-wave characteristic, etc. In this case, the isolation posts 102 within the second dielectric substrate 301 may be disposed in gaps of the grid structure. A positional relationship between the isolation posts 102 within the first dielectric substrate 100 and the isolation posts 102 within the second dielectric substrate 301 is not limited in the embodiments of the present disclosure.

As shown in FIG. 4, the array antenna includes a first dielectric substrate 100 and a second dielectric substrate 301 disposed oppositely, an antenna unit 200 includes a first antenna unit 201 and a second antenna unit 202, the first dielectric substrate 100 includes a first surface 1001 and a second surface 1002 disposed oppositely, multiple first antenna units 201 are disposed on the first surface 1001, a first conductive layer 401 is disposed on the second surface 1002, and multiple isolation posts 102 are disposed within the first dielectric substrate 100; the multiple first antenna units 201 are divided into multiple groups, and at least one isolation post 102 is disposed between two adjacent groups of the first antenna units 201. The second dielectric substrate 301 includes a third surface 3011 and a fourth surface 3012 disposed oppositely, a second conductive layer 402 is disposed on the third surface 3011, multiple second antenna units 202 are disposed on the fourth surface 3012, and multiple isolation posts 102 are disposed within the second dielectric substrate 301; the multiple second antenna units 202 are divided into multiple groups, and at least one isolation post 102 is disposed between two adjacent groups of the second antenna units 202. An orthographic projection of the second conductive layer 402 on the first dielectric substrate 100 partially overlaps with an orthographic projection of the first conductive layer 401 on the first dielectric substrate 100. The first conductive layer 401, the second conductive layer 402, and a third dielectric layer 403 disposed between the first conductive layer 401 and the second conductive layer 402 form a phase shifting structure 400. In some exemplary embodiments, the third dielectric layer 403 includes a liquid crystal material. However, the embodiments of the present disclosure are not limited to this. In some exemplary embodiments, the third dielectric layer may adopt another material which is similar to the liquid crystal material and can change a dielectric constant thereof based on a change of an electric field. For example, the third dielectric layer 403 may include a ferroelectric material.

In some exemplary embodiments, in a transmissive array antenna as shown in FIG. 4, the isolation posts 102 may be disposed only within the first dielectric substrate 100 and not disposed within the second dielectric substrate 301. Or, the isolation posts 102 may be disposed only within the second dielectric substrate 301 and not disposed within the first dielectric substrate 100. Or, the isolation posts 102 may be disposed within both the first dielectric substrate 100 and the second dielectric substrate 301. The present disclosure is not limited thereto.

A positional relationship between the first antenna unit 201 and the second antenna unit 202 is not limited in the embodiments of the present disclosure. When the array antenna is a symmetric antenna, an orthographic projection of the first antenna unit 201 on the first dielectric substrate 100 coincides with an orthographic projection of the second antenna unit 202 on the first dielectric substrate 100; and when the array antenna is an asymmetric antenna, the orthographic projection of the first antenna unit 201 on the first dielectric substrate 100 does not coincide with the orthographic projection of the second antenna unit 202 on the first dielectric substrate 100.

In the present embodiment, when the isolation posts 102 are disposed within both the first dielectric substrate 100 and the second dielectric substrate 301, isolation posts 102 within the first dielectric substrate 100 are arranged according to positions of the multiple first antenna units 201 on the first dielectric substrate for suppressing dielectric coupling between the multiple first antenna units 201 on the first dielectric substrate. Exemplarily, the isolation posts 102 within the first dielectric substrate 100 may be disposed in spaced regions around the first antenna units 201. Isolation posts 102 within the second dielectric substrate 301 are arranged according to positions of the multiple second antenna units 202 on the second dielectric substrate 301 for suppressing dielectric coupling between the multiple second antenna units 202 on the second dielectric substrate 301. Exemplarily, the isolation posts 102 within the second dielectric substrate 301 may be disposed in spaced regions around the second antenna units 202. Since the positional relationship between the first antenna unit 201 and the second antenna unit 202 is not limited in the embodiments of the present disclosure, a positional relationship between the isolation posts 102 within the first dielectric substrate 100 and the isolation posts 102 within the second dielectric substrate 301 is also not limited in the embodiments of the present disclosure, as long as the isolation posts 102 within the first dielectric substrate 100 and the isolation posts 102 within the second dielectric substrate 301 are arranged according to positions of the antenna units on the first dielectric substrate and the second dielectric substrate, respectively.

An architecture and lamination of the array antenna of the embodiment of the present disclosure may be in various modes, and the isolation posts 102 may be flexibly applied to multiple forms of array antennas such as a reflective type array antenna, a transmissive type array antenna, a glass-based type array antenna, and the like to improve an isolation degree of the array antenna.

In some exemplary embodiments, as shown in FIGS. 1 to 4, the first dielectric substrate 100 further includes spaced regions 203 around the antenna units 200, wherein an orthographic projection of the spaced regions 203 on the first dielectric substrate 100 includes an orthographic projection of the isolation posts 102 on the first dielectric substrate 100.

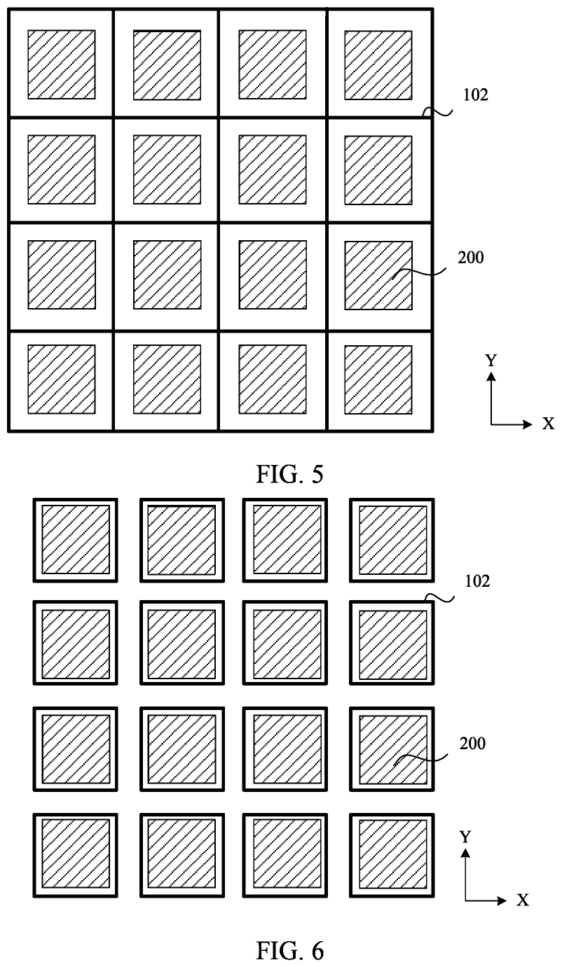

In an embodiment of the present disclosure, an arrangement of the isolation posts 102 based on the antenna units 200 may take many forms, and a distribution path thereof may be and is not limited to four forms as in FIGS. 5 to 8.

In some exemplary embodiments, as shown in FIGS. 5 and 7, the isolation posts 102 are arranged in multiple rows and multiple columns, and at least one row of the isolation posts 102 is disposed between two adjacent groups of the antenna units 200 in a first direction X; and at least one column of the isolation posts 102 is disposed between two adjacent groups of the antenna units 200 in a second direction Y.

In some exemplary embodiments, the first direction X intersects with the second direction Y. Exemplarily, the first direction X and the second direction Y are perpendicular to each other.

In some exemplary embodiments, as shown in FIG. 5, the multiple antenna units 200 include m rows and n columns, m and n are natural numbers, each group of the antenna units 200 includes one antenna unit 200, and the multiple isolation posts 102 are arranged in (m+1) rows and (n+1) columns; two sides of a first row of the antenna units 200 to two sides of an m-th row of the antenna units 200 are all provided with one row of the isolation posts 102; and two sides of a first column of the antenna units 200 to two sides of an n-th column of the antenna units 200 are all provided with one column of the isolation posts 102.

In some exemplary embodiments, as shown in FIG. 7, the multiple antenna units 200 include m rows and n columns, m and n are natural numbers, each group of the antenna units 200 includes one antenna unit 200, and the multiple isolation posts 102 are arranged in (m−1) rows and (n−1) columns; two sides of a second row of the antenna units 200 to two sides of an (m−1)-th row of the antenna units 200 are all provided with one row of the isolation posts 102; and two sides of a second column of the antenna units 200 to two sides of an (n−1)-th column of the antenna units 200 are all provided with one column of the isolation posts 102.

In some exemplary embodiments, as shown in FIGS. 5, 6, and 8, an arrangement of the isolation posts 102 forms multiple enclosed patterns, wherein at least one enclosed pattern is disposed around one group of the antenna units 200.

In some exemplary embodiments, the multiple antenna units 200 include m rows and n columns of antenna units, m and n are natural numbers, and each group of the antenna units 200 includes a*b antenna units, wherein 1≤a≤m, and 1≤b≤n; and an arrangement of the isolation posts 102 forms (m/a)*(n/b) enclosed patterns, wherein each enclosed pattern surrounds one group of the antenna units 200.

Exemplarily, as shown in FIG. 6, a=1, b=1, each group of the antenna units 200 includes one antenna unit 200, the arrangement of the isolation posts 102 forms m*n enclosed patterns, and each enclosed pattern surrounds one antenna unit 200. As shown in FIG. 8, a=2, b=2, each group of the antenna units 200 includes four antenna units 200, the arrangement of the isolation posts 102 forms (m/2)*(n/2) enclosed patterns, and each enclosed pattern surrounds four antenna units 200.

In an embodiment of the present disclosure, a distribution mode of the isolation posts 102 is generally periodic, which may be flexibly adjusted, according to an array feeding structure, into multiple periodic combination modes such as one group of the isolation posts corresponding to a single antenna unit (as shown in FIGS. 5 to 7), one group of the isolation posts corresponding to a dual-antenna unit (not shown in the figure), and one group of the isolation posts corresponding to a four-antenna units (as shown in FIG. 8). The isolation posts 102 may be disposed as a periodic edge sharing type (as shown in FIGS. 5 and 7), or a periodic edge non-sharing type (as shown in FIGS. 6 and 8).

In some exemplary embodiments, a shape of the enclosed pattern formed by the arrangement of the isolation posts 102 includes a straight polygon (e.g., a triangle, a rectangle, a square, a parallelogram, a regular pentagon, a regular hexagon, etc.), a curved polygon (e.g., a circle, an ellipse, etc.), or an enclosed pattern composed of a straight line and a curve (e.g., a rounded rectangle, etc.).

In some exemplary embodiments, the first dielectric substrate 100 includes a first surface 1001 and a second surface 1002 disposed oppositely, wherein the antenna units 200 are disposed on the first surface 1001; and the isolation posts 102 satisfy at least one of the following: the isolation posts 102 penetrate at least one of the first surface 1001 and the second surface 1002; or, the isolation posts 102 are disposed inside the first dielectric substrate 100, and the isolation posts 102 do not penetrate the first surface 1001 or the second surface 1002.

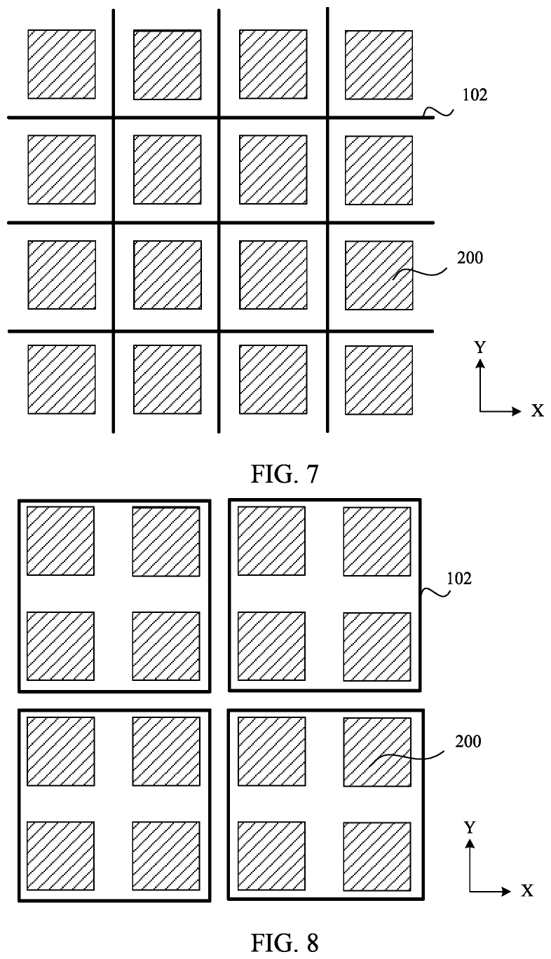

In an embodiment of the present disclosure, puncturing positions of the isolation posts 102 in the first dielectric substrate 100 may have multiple forms, and a puncturing mode thereof may be and is not limited to four forms enumerated in FIGS. 9A to 9D: the isolation posts 102 may be in a form of upper and lower penetration (as shown in FIG. 9A), or only upper layer penetration or only lower layer penetration, with the other side terminated inside a glass dielectric (as shown in FIGS. 9B and 9C), or upper and lower layers non-penetration, but terminated inside a glass dielectric (as shown in FIG. 9D). In a practical use, which form to use may be determined according to a process condition and a distribution of upper and lower metal layers.

In some exemplary embodiments, a spacing between two adjacent isolation posts 102 corresponding to one same group of the antenna units 200 is less than or equal to 0.25* a central wavelength, wherein the center wavelength is a wavelength corresponding to a center frequency of an electromagnetic wave received and transmitted by the array antenna. Exemplarily, the spacing between two adjacent isolation posts 102 corresponding to the same group of the antenna units 200 is less than or equal to 0.125* a center wavelength.

In an embodiment of the present disclosure, a spacing between an isolation post 102 and a group of the antenna units should be a reasonable numerical value set within a process precision range, while it can ensure an effective coupling energy shielding effect.

In some exemplary embodiments, a spacing between the antenna unit 200 and the isolation post 102 corresponding to the antenna unit 200 is less than or equal to 0.25* a central wavelength, wherein the center wavelength is a wavelength corresponding to a center frequency of an electromagnetic wave received and transmitted by the array antenna. Exemplarily, the spacing between the antenna unit 200 and the isolation post 102 corresponding to the antenna unit 200 is less than or equal to 0.125* a center wavelength.

In an embodiment of the present disclosure, a spacing between the isolation post 102 and the antenna unit 200 should be reasonably set by considering both a weakening effect of an coupling energy and an influence effect of the isolation post 102 on a performance of the antenna unit 200 itself.

In some exemplary embodiments, when a spacing of the isolation posts 102 is less than 0.125* a center wavelength (exemplarily, a working center frequency in the embodiment of the present disclosure may be, but is not limited to, 78 GHz, corresponding to the center wavelength of 38.46 mm.), and the isolation posts 102 are at most edge positions of the units, a shielding effect is best.

In an embodiment of the present disclosure, specific physical dimensions are calculated in terms of electrical length, wherein the center wavelength corresponds to its working center frequency, and is calculated and converted into a corresponding specific physical dimension. The working center frequency in the embodiment of the present disclosure may be, but is not limited to, 78 GHz, corresponding to the center wavelength of 38.46 mm.

In some exemplary embodiments, a shape of the isolation post 102 may be a cylinder, a polygonal prism, or an irregular column, etc.

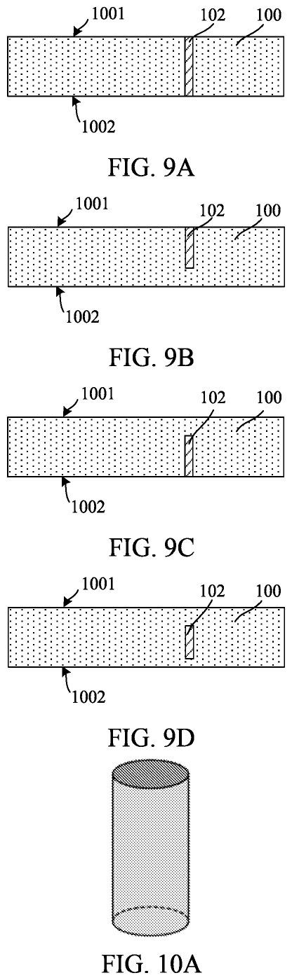

In an embodiment of the present disclosure, the isolation post 102 is formed based on a dielectric perforation and a via hole metallization process. The shape of the isolation post 102 may be and is not limited to a cylinder, a polygonal prism, or an irregular column, etc., as shown in FIGS. 10A to 10E. When the isolation posts 102 are of shapes shown in FIGS. 10A to 10D, the multiple isolation posts 102 are dispersed; when the isolation posts 102 are of the shape of a cuboid metal wall shown in FIG. 10E, the isolation posts 102 disposed between two adjacent groups of the antenna units 200 may be in a continuous structure, or may be in a dispersed structure composed of multiple cuboid metal walls, which is not limited in the present disclosure. In a practical use, the shape of the isolation post 102 may be comprehensively decided according to an array spacing, a processing process, and a design cost. In some exemplary embodiments, the shape of the isolation post 102 adopts a cylindrical hole design, a process thereof is relatively simple, and a subsequent process is relatively easy to perform, while it has a relatively good coupling energy shielding effect. In some other exemplary embodiments, the shape of the isolation posts 102 adopts a cuboid metal wall design. In this case, a signal shielding effect of the isolation posts 102 is relatively strong, and a better isolation effect can be achieved, but its processing difficulty is relatively large.

In an embodiment of the present disclosure, the isolation posts 102 may be of a continuous structure (exemplarily, as shown in FIG. 10E), or may be of a dispersed configuration (exemplary, as shown in FIGS. 10A to 10D). Since the isolation posts 102 are usually metal materials, in order not to affect a distribution of metal traces on a surface of the first dielectric substrate 100, when the isolation posts 102 adopt the cuboid metal wall structure as shown in FIG. 10E, they are usually continuously distributed within a certain section of region, and gaps are left between adjacent cuboid metal wall structures for the distribution of the metal traces on the surface of the first dielectric substrate 100.

In some exemplary embodiments, the isolation post 102 may be a solid column or a hollow column.

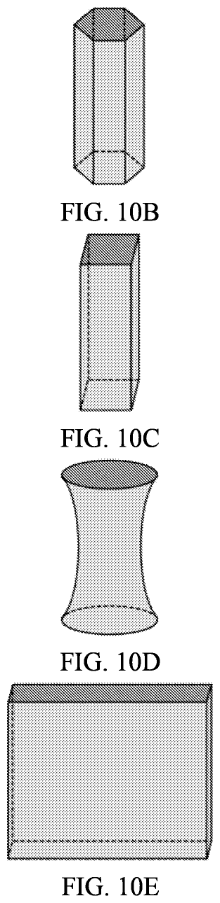

As shown in FIGS. 11A and 11B, in an embodiment of the present disclosure, a process for preparing the isolation post 102 may be, but is not limited to, multiple forms such as metal filling, metal attaching, and the like. When the metal filling process is adopted, the isolation post 102 is a solid column filled in an isolation cavity; and when the metal attaching process is adopted, the isolation post 102 is a hollow column attached to an isolation cavity.

In an exemplary implementation, a material of the isolation post 102 may be metal. Exemplarily, the material of the isolation post 102 may be, but is not limited to, common conductive metals such as copper, aluminum, and the like.

In some exemplary embodiments, the first dielectric substrate 100 may be glass or another material such as a Printed Circuit Board (PCB), etc.

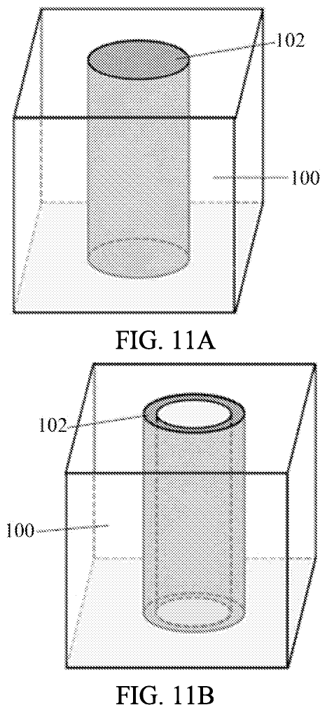

FIG. 12 is a schematic diagram of a comparison of isolation degrees between antenna units before and after isolation posts are added in an array antenna according to an exemplary embodiment of the present disclosure. In FIG. 12, a horizontal ordinate represents a frequency (in a unit of GHz), and a longitudinal ordinate is an isolation degree (in a unit of dB). As shown in FIG. 12, although when the frequency is greater than or equal to 79 GHz, an isolation degree between antenna units is reduced after isolation posts are added, isolation degrees between adjacent antenna units are all less than −18 dB at 72 GHz to 86 GHz, that is, the isolation degrees between adjacent antenna units are reduced to below −15 dB, and the isolation effect is relatively good.

At least one embodiment of the present disclosure further provides a method for preparing an array antenna, which is used for preparing the array antenna as described above.

In some exemplary embodiments, the preparation method includes: forming multiple isolation posts within a first dielectric substrate; and forming multiple antenna units on the first dielectric substrate, wherein the multiple antenna units are divided into multiple groups, and at least one isolation post is disposed between two adjacent groups of the antenna units.

The preparation method in the embodiment may refer to the descriptions in the above-mentioned embodiments, and thus will not be repeated herein.

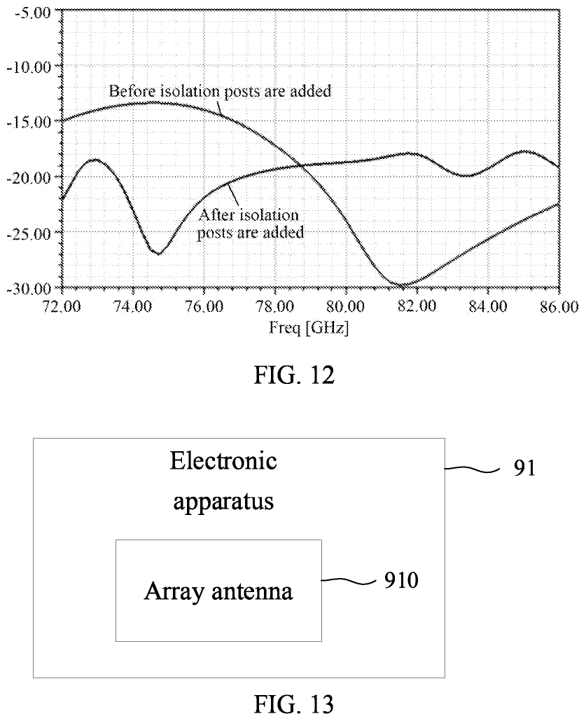

At least one embodiment of the present disclosure further provides an electronic apparatus. FIG. 13 is a schematic diagram of a structure of an electronic apparatus according to at least one embodiment of the present disclosure. As shown in FIG. 13, the present embodiment provides an electronic apparatus 91, which includes: an array antenna 910 as described above. The electronic device 91 may be any product or component with communication functions such as a smart phone, a navigation device, a game machine, a television (TV), a car audio, a tablet computer, a Personal Multimedia Player (PMP), a Personal Digital Assistant (PDA), etc. However, the present embodiments are not limited thereto.

The drawings of the present disclosure only involve structures involved in the present disclosure, and other structures may refer to conventional designs. The embodiments of the present disclosure and features in the embodiments may be combined to each other to obtain new embodiments if there is no conflict.

Those of ordinary skills in the art should understand that modifications or equivalent replacements of the technical solutions of the present disclosure may be made without departing from the spirit and scope of the technical solutions of the present disclosure, and shall all fall within the scope of the claims of the present disclosure.

1. An array antenna, comprising: a first dielectric substrate and a plurality of antenna units disposed on the first dielectric substrate, wherein:
a plurality of isolation posts are disposed within the first dielectric substrate;
the plurality of antenna units are divided into a plurality of groups, and at least one isolation post is disposed between two adjacent groups of antenna units.

2. The array antenna of claim 1, wherein the first dielectric substrate further comprises spaced regions around the antenna units, and an orthographic projection of the spaced regions on the first dielectric substrate comprises an orthographic projection of the isolation posts on the first dielectric substrate.

3. The array antenna of claim 1, wherein the isolation posts are arranged in a plurality of rows and a plurality of columns, and at least one row of isolation posts is disposed between two adjacent groups of antenna units in a first direction; and
at least one column of isolation posts is disposed between two adjacent groups of antenna units in a second direction.

4. The array antenna of claim 3, wherein the plurality of antenna units comprise m rows and n columns of antenna units, where m and n are natural numbers, each group of antenna units comprises one antenna unit, and the plurality of isolation posts are arranged in (m+1) rows and (n+1) columns;
two sides of a first row of antenna units to two sides of an m-th row of antenna units are all provided with one row of isolation posts; and
two sides of a first column of antenna units to two sides of an n-th column of antenna units are all provided with one column of isolation posts.

5. The array antenna of claim 3, wherein the plurality of antenna units comprise m rows and n columns of natural numbers, where m and n are natural numbers, each group of antenna units comprises one antenna unit, and the plurality of isolation posts are arranged in (m−1) rows and (n−1) columns;
two sides of a second row of antenna units to two sides of an (m−1)-th row of antenna units are all provided with one row of isolation posts; and
two sides of a second column of antenna units to two sides of an (n−1)-th column of antenna units are all provided with one column of isolation posts.

6. The array antenna of claim 1, wherein an arrangement of the isolation posts forms a plurality of enclosed patterns, and at least one of the plurality of enclosed patterns is disposed around one group of antenna units.

7. The array antenna of claim 6, wherein the plurality of antenna units comprise m rows and n columns of antenna units, where m and n are natural numbers, and each group of antenna units comprises a*b antenna units, where 1≤a≤m, and 1≤b≤n;
an arrangement of the isolation posts forms (m/a)*(n/b) enclosed patterns, and each of the enclosed patterns is disposed around one group of antenna units.

8. The array antenna of claim 1, wherein the first dielectric substrate comprises a first surface and a second surface disposed oppositely, and the antenna units are disposed on the first surface; and the isolation posts satisfy at least one of the following:
the isolation posts penetrate at least one of the first surface and the second surface; or
the isolation posts are disposed inside the first dielectric substrate, and the isolation posts do not penetrate the first surface or the second surface.

9. The array antenna of claim 1, wherein a spacing between two adjacent isolation posts corresponding to one same group of antenna units is less than or equal to 0.25* a center wavelength, wherein * is a multiplication sign, and the center wavelength is a wavelength corresponding to a center frequency of an electromagnetic wave received and transmitted by the array antenna.

10. The array antenna of claim 1, wherein a spacing between an antenna unit and an isolation post corresponding to the antenna unit is less than or equal to 0.25* a center wavelength, wherein * is a multiplication sign, and the center wavelength is a wavelength corresponding to a center frequency of an electromagnetic wave received and transmitted by the array antenna.

11. The array antenna of claim 1, wherein a shape of the isolation post is a cylinder, a polygonal prism, or an irregular column.

12. The array antenna of claim 1, wherein the isolation post is a solid column or a hollow column.

13. The array antenna of claim 1, wherein a material of the isolation post is metal.

14. The array antenna of claim 1, wherein the first dielectric substrate is a glass or printed circuit board dielectric substrate.

15. The array antenna of claim 1, wherein the array antenna is a transmissive liquid crystal array antenna, a reflective liquid crystal array antenna, or a glass-based array antenna.

16. An electronic apparatus, comprising at least one array antenna of claim 1.

17. A method for preparing an array antenna, which is for preparing the array antenna of claim 1, comprising:
forming a plurality of isolation posts within a first dielectric substrate; and
forming a plurality of antenna units on the first dielectric substrate, wherein the plurality of antenna units are divided into a plurality of groups, and at least one isolation post is disposed between two adjacent groups of antenna units.
